(19) United States
(12) Patent Application Publication
(10) Pub. No.: US 2014/0068125 A1
(43) Pub. Date: Mar. 6, 2014

(54) MEMORY THROUGHPUT IMPROVEMENT USING ADDRESS INTERLEAVING

(71) Applicants: Sakthivel K. Pullagoundapatti, Panathur (IN); Krishna V. Bhandi, Kasturi Nagar (IN); Claus Pribbernow, Munich (DE)

(72) Inventors: Sakthivel K. Pullagoundapatti, Panathur (IN); Krishna V. Bhandi, Kasturi Nagar (IN); Claus Pribbernow, Munich (DE)

(73) Assignee: LSI Corporation, Milpitas, CA (US)

(21) Appl. No.: 13/599,249

(22) Filed: Aug. 30, 2012

(51) Int. Cl. G06F 13/00

(52) U.S. Cl. 710/110

(57) ABSTRACT

Aspects of the disclosure pertain to a system and method for promoting memory throughput improvement in a multi-processor system. The system and method implement address interleaving for promoting memory throughput improvement. The system and method cause memory access requests to be selectively routed from master devices to slave devices based upon a determined value of a selected bit of an address specified in the memory access request.

### BACKGROUND

A system on chip (SoC) is an integrated circuit that is used to integrate all components of a computer or other electronic system into a single chip. Current SoC systems can suffer from several performance issues.

### SUMMARY

This Summary is provided to introduce a selection of concepts in a simplified form that are further described below in the Detailed Description. This Summary is not intended to identify key and/or essential features of the claimed subject matter. Also, this Summary is not intended to limit the scope of the claimed subject matter in any manner

Aspects of the disclosure pertain to a system and method for promoting memory throughput improvement in a multi-processor system.

### BRIEF DESCRIPTION OF THE DRAWINGS

FIG. 1 is an example conceptual block diagram schematic of a multi-processor system;

FIG. 2 is an example conceptual block diagram schematic of another multi-processor system;

FIG. 3 is a table indicating example interleaved accesses for the example multi-processor system shown in FIG. 1; and

FIG. 4 is a flow chart illustrating a method for promoting improvement of memory throughput in a multi-processor system.

### DETAILED DESCRIPTION

Aspects of the disclosure are described more fully hereinafter with reference to the accompanying drawings, which form a part hereof, and which show, by way of illustration, example features. The features can, however, be embodied in many different forms and should not be construed as limited to the combinations set forth herein; rather, these combinations are provided so that this disclosure will be thorough and complete, and will fully convey the scope. Among other things, the features of the disclosure can be facilitated by methods, devices, and/or embodied in articles of commerce. The following detailed description is, therefore, not to be taken in a limiting sense.

A system on chip (SoC) is an integrated circuit that integrates all components of a computer or other electronic system into a single chip. A SoC can contain digital, analog, mixed-signal and often, radio-frequency functions, all on a single chip substrate. An application area for SoC technology can be in the area of embedded systems.

In a typical SoC system, master devices generate and transmit memory access requests to a plurality of slave devices for the purpose of reading data from or writing data to a memory of the system. In response to receiving the transmitted memory access requests, the slave devices generate and transmit commands (e.g., read commands, write commands) to a memory of the system for servicing (e.g., fulfilling) the memory access requests. An address space is associated with the memory. In a typical SoC system, a first slave device instantiates a first portion of the address space of the memory, while a second slave device instantiates a second portion of the address space of the memory. The first portion corresponds to a first address range associated with the address space, the second portion corresponds to a second address range associated with the address space, the first and second address ranges being non-overlapping. Each memory access request specifies (e.g., includes) an address associated with the address space. For example, in the typical SoC system, if only two slave devices are included in the system, each memory access request specifies (e.g., includes) an address which falls within either the first address range or the second address range.

In the typical SoC system, a static routing methodology is implemented. For example, when the address specified in a memory access request transmitted by a master device falls within the first address range, that memory access request is routed, via a bus interconnect, to the first slave device and is serviced by the first slave device. Alternatively, when the address specified in a memory access request transmitted by a master device falls within the second range, that memory access request is routed, via the bus interconnect, to the second slave device and is serviced by the second slave device. In the above-referenced static routing methodology, when memory access requests are transmitted to the bus interconnect from multiple master devices, the memory access requests can be routed so that they can be serviced in parallel, as long as the addresses in the memory access requests fall within different, non-overlapping address ranges. However, in some scenarios, the above-referenced static routing methodology implemented by typical SoC systems can be inefficient. For example, under the above-referenced static routing methodology, a scenario is possible in which the first slave device could receive a first memory access request, and then, prior to completing servicing of the first memory access request, could receive subsequent memory access requests (because the first memory access request and the subsequent memory access request all specify address ranges falling within the first address range). In such instances, prioritization of the subsequently received access requests occurs, resulting in higher priority access requests being serviced by the first slave device, while servicing of lower priority access requests is delayed or stalled, even though the second slave device is idle. This delayed servicing of the lower priority access requests by the slave device (e.g., access latency) can degrade performance of the system by affecting memory throughput.

As more fully set forth below, aspects of the disclosure include a system configured for promoting reduction of access latency to the slave devices of the system by using address interleaving, thereby promoting improved performance (e.g., memory throughput) of the system.

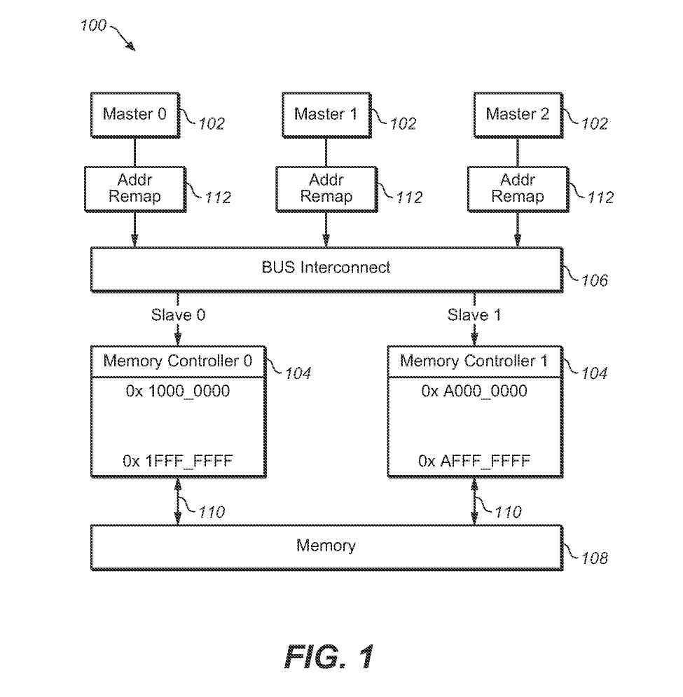

As indicated in FIG. 1 (FIG. 1), a system 100 is shown. In embodiments, the system 100 can be a multi-processor system. For example, the multi-processor system can be incorporated into a system on chip (SoC) system, which is an integrated circuit that integrates a plurality of intellectual property components (e.g., of a computer) into a single chip (e.g., a dielectric substrate, printed circuit board) and is configured for running one or more applications. The system 100 can include a plurality of master devices (e.g., masters, requestors, initiators) 102. For instance, the master devices 102 can be processors, such as multi-core processors (e.g., Cortex™-R4 processors, Cortex™-R5 processors). The master devices 102 can be configured for generating and transmitting memory access requests (e.g., read requests, write requests, bursts, transactions, accesses, burst accesses, burst operations) for particular applications running on the system 100. In embodiments, each transmitted memory access request can be configured such that it is based upon a size of a cache line (e.g., cache-line size) of a cache and/or an address boundary of the transmitting master device 102. For example, the transmitted memory access request can be configured so that it does not cross a 32-byte address boundary. In other examples, depending on the system being implemented, the address boundary (e.g., total address width) could be any of a number of other values besides 32-bytes, and the transmitted memory access request can be configured so that it does not cross that address boundary. Cache-line size (e.g., cache-line fill) can be the size of the smallest unit of memory that can be transferred between main memory of the system 100 and the cache of master device 102. In the illustrated embodiment shown in FIG. 1, the system 100 implements three master devices 102.

The system 100 can further include a plurality of slave devices (e.g., slaves) 104. For example, the slave devices 104 can be memory controllers (e.g., Synchronous Random Access Memory (SRAM) memory controllers). The slave devices (e.g., memory controllers) 104 can be digital circuits which manage the flow of data going to and from a main memory. The slave devices (e.g., memory controllers) 104 can include logic for reading data from and writing data to a memory (e.g., main memory) 108 of the system 100. The plurality of slave devices 104 can be connected to the plurality of master devices 102 by a bus interconnect 106. For example, bus interconnect 106 can be an Advanced Microcontroller Bus Architecture High-Performance Bus (AHB) interconnect, an Advanced eXtensible Interface (AXI) interconnect, or the like. The slave devices 104 can be configured for receiving the memory access requests transmitted by the master devices 102 via the bus interconnect 106. The slave devices 104 can be further configured for generating and transmitting commands (e.g., read commands, write commands) for servicing (e.g., fulfilling) the memory access requests, the commands being based upon (e.g., derived from) the received memory access requests. In the illustrated embodiment shown in FIG. 1, the system 100 implements two slave devices 104.

As mentioned above, the system 100 can further include memory 108. For example, the memory 108 can be Static Random Access Memory (SRAM). SRAM can be a type of semiconductor memory that uses bistable latching circuitry to store each bit. In embodiments, an address space (e.g., a 512 Megabyte (MB) address space) can be associated with the memory 108. The memory 108 can be connected to the plurality of slave devices 104 by a memory interface 110. The memory interface 110 can be a data bus, such as a bi-directional data bus (e.g., a command bus), which can be configured for use in writing data to and reading data from the memory 108.

The slave devices 104 can be configured for scheduling servicing of the memory access requests received from the master devices 102. For example, since the system 100 can be configured such that the master devices 102 share access to memory 108, the slave devices 104 can be configured for scheduling servicing of the memory access requests in a manner which promotes maximized servicing of the memory access requests, promotes memory efficiency, and/or promotes minimized power consumption. Scheduling of servicing of the memory access requests by the slave devices 104 can be based on a number of factors, such as properties of the memory access requests, histories of the requestors and the state of the memory 108. Further, the slave devices 104 can be configured for providing memory mapping functionality, such that the slave devices 104 can be configured for translating logical addresses specified in the memory access requests into physical addresses. As mentioned above, the commands generated by the slave devices 104 are based upon (e.g., derived from) the received memory access requests, the commands further being based upon the memory mapping functionality performed by the slave devices 104. Still further, the slave devices 104 can be configured for providing memory management functionality (e.g., refreshing of the memory, memory configuration, powering down and/or initialization).

The slave devices 104 can be configured for receiving data from the memory 108, the data can include data which was requested via the commands transmitted from the slave devices 104 to the memory 108. The slave devices 104 can be further configured for providing responses to the master devices 102, the responses being responsive to the memory access requests transmitted by the master devices 102.

The slave devices (e.g., memory controllers) 104 can be configured for instantiating separate portions of the address space of the memory 108. For example, in the illustrated embodiment in FIG. 1, where two slave devices 104 are being implemented, the first slave device (e.g. identified as “Memory Controller 0” in FIG. 1) can be configured for instantiating a first portion (e.g., a 256 MB portion) of the address space (e.g., a 512 MB address space) of the memory 108, while the second slave device (e.g. identified as “Memory Controller 1” in FIG. 1) can be configured for instantiating a second portion (e.g., a 256 MB portion) of the address space of the memory 108, the first and second portions being separate (e.g., non-overlapping) portions of the address space of the memory 108. The first portion corresponds to a first address range associated with the address space of the memory 108, the second portion corresponds to a second address range associated with the address space of the memory 108, the first and second address ranges being non-overlapping.

Each memory access request transmitted by the master devices 102 specifies (e.g., includes) an address associated with the address space of the memory 108. For example, where two slave devices are being implemented, as shown in the illustrated system embodiment depicted in FIG. 1, each memory access request can specify (e.g., include) an address which falls within either the first address range or the second address range. Further, any of the master devices 102 can be configured for accessing the complete address space (e.g., 512 MB address space) of the memory 108 via the bus interconnect 106.

In embodiments, the system 100 can further include address mapping logic (e.g., address remap logic) 112. The address mapping logic 112 can be implemented as hardware, software, and/or firmware. The address mapping logic 112 can be configured (e.g., connected) between the master devices 102 and the bus interconnect 106 and can be further configured for implementing address interleaving for causing the memory access requests to be selectively routed to the slave devices 104 via the bus interconnect 106. The address mapping logic 112 can be configured for determining a value of a selected bit (e.g., binary digit) of the address specified in a memory access request transmitted from a master device 102. Selection of the address bit upon which address interleaving can be based can be determined by the cache-line size of the cache of the master device 102 which transmitted the memory access request. The selected address bit can be a pre-determined (e.g., pre-selected) address bit. For example, the mapping logic 112 can be configured for determining a value of bit [5] of the address specified in the transmitted memory access request. It is contemplated that selection of the address bit (e.g., the address bit to be interleaved) can be determined based upon other metrics besides or in addition to the cache-line size, such as the application and/or usage model. For example, if an application performs only 64-byte transfers to memory, then the selected bit (e.g., the interleaving bit) can be bit [6] of the address specified in the memory access request and the mapping logic 112 can be configured for determining a value of bit [6] of the address specified in the transmitted memory access request. Further, the address mapping logic 112 can be further configured for, when the value of the bit is determined as being a first value, causing the memory access request to be routed, via the bus interconnect 106, to a first slave device included in the plurality of slave devices 104. For example, when the value of the bit (e.g., bit [5]) is determined as being “0”, the address mapping logic 112 causes the memory access request to be routed, via the bus interconnect 106, to a first slave device (e.g., “memory controller 0” or “slave 0”, as indicated in FIG. 1) included in the plurality of slave devices 104.

Still further, the address mapping logic 112 can be further configured for, when the value of the bit is determined as being a second value, the second value being a different value than the first value, causing the memory access request to be routed, via the bus interconnect 106, to a second slave device included in the plurality of slave devices 104. For example, when the value of the bit (e.g., bit [5]) is determined as being “1”, the address mapping logic 112 causes the memory access request to be routed, via the bus interconnect 106, to a second slave device (e.g., “memory controller 1” or “slave 1”, as indicated in FIG. 1). The address mapping logic 112 can be configured for causing the memory access request to be routed, via the bus interconnect, to the second slave device 104 through implementation of address interleaving, which includes routing bit [5] of the address specified in the memory access request to a Most Significant Bit (MSB) [31] address bit. In other embodiments (e.g., such as those in which the cache-line size of the cache of the master device 102 which transmitted the memory access request is 64 bytes), bit [6] of the address specified in the memory access request can be routed to MSB [31]. This causes the address specified in the memory access request to effectively be changed to an address (e.g., a remap address) which causes the bus interconnect 106 to route it to the second slave device. For example, if the address as specified in the transmitted memory access request falls within the first address range, but the value of the selected bit is determined as being a value which dictates that the memory access request is to be routed to the second slave device, the address may be changed to a remap address which falls within the second address range.

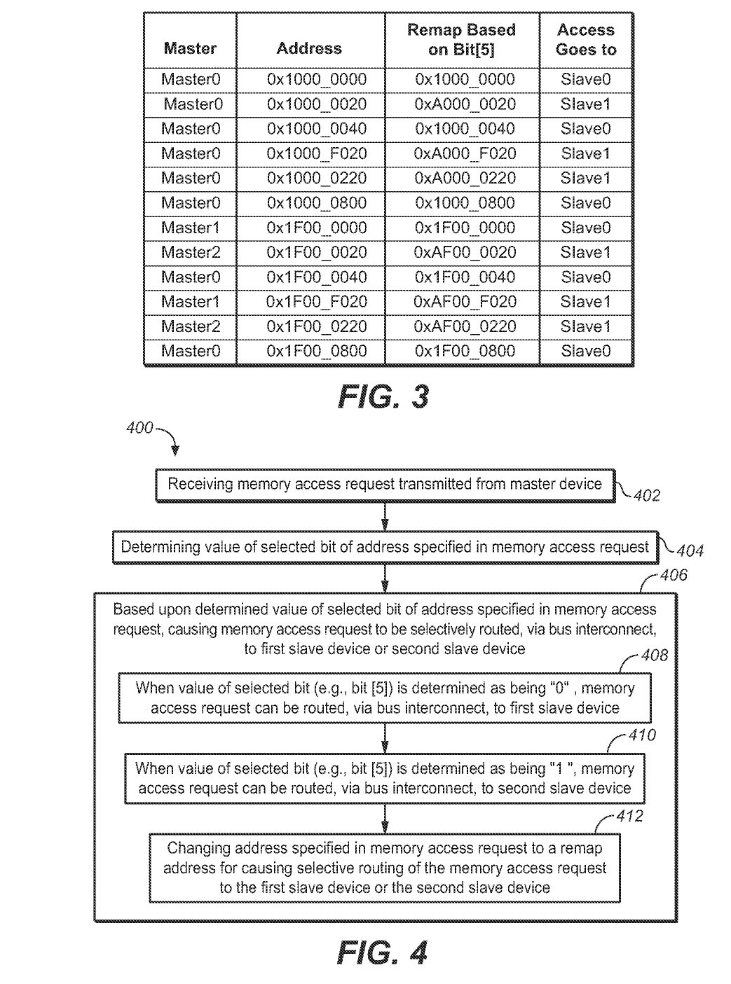

FIG. 3 shows a table indicating data corresponding to a set of memory access requests, the data including: a) the identity of the master device the memory access request was transmitted from; b) the address specified in the memory access request; c) the remap address based on bit [5] for each memory access request; and d) the identity of the slave device to which each memory access request was routed.

In embodiments, the address remap logic 112, by implementing address interleaving as described above, allows for memory access requests to be routed in such a manner so that they are equally distributed amongst the slave devices 104. This promotes reduction of access latency, improved memory throughput, and improved overall performance of the system 100. The above-referenced address remapping functionality implemented by the address remap logic 112 can be easily scalable for adapting to any number of masters and slaves.

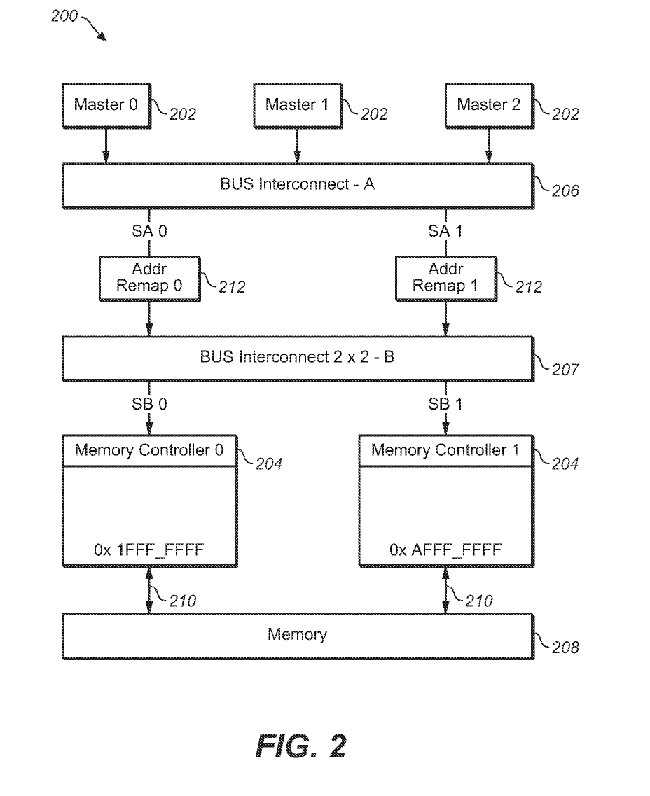

As indicated in FIG. 2 (FIG. 2), a system 200 is shown. In embodiments, the system 200 can be a multi-processor system. For example, the multi-processor system can be incorporated into a system on chip (SoC) system, which is an integrated circuit that integrates a plurality of intellectual property components (e.g., of a computer) into a single chip and is configured for running one or more applications. The system 200 can include a plurality of master devices (e.g., masters, requestors, initiators) 202. For instance, the master devices 202 can be processors, such as multi-core processors (e.g., Cortex™-R4 processors, Cortex™-R5 processors). The master devices 202 can be configured for generating and transmitting memory access requests (e.g., read requests, write requests, bursts, transactions, accesses, burst accesses, burst operations) for particular applications running on the system 200. In embodiments, each transmitted memory access request can be configured such that it is based upon a size of a cache line (e.g., cache-line size) of a cache and/or an address boundary of the transmitting master device 202. For example, the transmitted memory access request can be configured so that it does not cross a 32-byte address boundary. In other examples, depending on the system being implemented, the address boundary (e.g., total address width) could be any of a number of other values besides 32-bytes, and the transmitted memory access request can be configured so that it does not cross that address boundary. Cache-line size (e.g., cache-line fill) can be the size of the smallest unit of memory that can be transferred between main memory of the system 200 and the cache of master device 202. In the illustrated embodiment shown in FIG. 2, the system 200 implements three master devices 202.

The system 200 can further include a plurality of slave devices (e.g., slaves) 204. For example, the slave devices 204 can be memory controllers (e.g., Synchronous Random Access Memory (SRAM) memory controllers). The slave devices (e.g., memory controllers) 204 can be digital circuits which manage the flow of data going to and from a main memory. The slave devices (e.g., memory controllers) 204 can include logic for reading data from and writing data to a memory (e.g., main memory) 208 of the system 200. The plurality of slave devices 204 can be connected to the plurality of master devices 202 by a first bus interconnect 206 and a second bus interconnect 207. For example, the bus interconnects (206, 207) can be Advanced Microcontroller Bus Architecture High-Performance Bus (AHB) interconnects, Advanced eXtensible Interface (AXI) interconnects, or the like. Further, the second bus interconnect 207 can be a 2×2 interconnect. The slave devices 204 can be configured for receiving the memory access requests transmitted by the master devices 202 via the bus interconnects 206, 207. The slave devices 204 can be further configured for generating and transmitting commands (e.g., read commands, write commands) for servicing (e.g., fulfilling) the memory access requests, the commands being based upon (e.g., derived from) the received memory access requests. In the illustrated embodiment shown in FIG. 2, the system 200 implements two slave devices 204.

As mentioned above, the system 200 can further include memory 208. For example, the memory 208 can be Synchronous Random Access Memory (SRAM). SRAM can be a type of semiconductor memory that uses bistable latching circuitry to store each bit. In embodiments, an address space (e.g., a 512 Megabyte (MB) address space) can be associated with the memory 208. The memory 208 can be connected to the plurality of slave devices 204 by a memory interface 210. The memory interface 210 can be a data bus, such as a bi-directional data bus (e.g., a command bus), which can be configured for use in writing data to and reading data from the memory 208.

The slave devices 204 can be configured for scheduling servicing of the memory access requests received from the master devices 202. For example, since the system 200 can be configured such that the master devices 202 share access to memory 208, the slave devices 204 can be configured for scheduling servicing of the memory access requests in a manner which promotes maximized servicing of the memory access requests, promotes memory efficiency, and/or promotes minimized power consumption. Scheduling of servicing of the memory access requests by the slave devices 204 can be based on a number of factors, such as properties of the memory access requests, histories of the requestors and the state of the memory 208. Further, the slave devices 204 can be configured for providing memory mapping functionality, such that the slave devices 204 can be configured for translating logical addresses specified in the memory access requests into physical addresses. As mentioned above, the commands generated by the slave devices 204 are based upon (e.g., derived from) the received memory access requests, the commands further being based upon the memory mapping functionality performed by the slave devices 204. Still further, the slave devices 204 can be configured for providing memory management functionality (e.g., refreshing of the memory, memory configuration, powering down and/or initialization).

The slave devices 204 can be configured for receiving data from the memory 208, the data can include data which was requested via the commands transmitted from the slave devices 204 to the memory 208. The slave devices 204 can be further configured for providing responses to the master devices 202, the responses being responsive to the memory access requests transmitted by the master devices 202.

The slave devices (e.g., memory controllers) 204 can be configured for instantiating separate portions of the address space of the memory 208. For example, in the illustrated embodiment in FIG. 2, where two slave devices 204 are being implemented, the first slave device (e.g. identified as “Memory Controller 0” in FIG. 2) can be configured for instantiating a first portion (e.g., a 256 MB portion) of the address space (e.g., a 512 MB address space) of the memory 208, while the second slave device (e.g. identified as “Memory Controller 1” in FIG. 2) can be configured for instantiating a second portion (e.g., a 256 MB portion) of the address space of the memory 208, the first and second portions being separate (e.g., non-overlapping) portions of the address space of the memory 208. The first portion corresponds to a first address range associated with the address space of the memory 208, the second portion corresponds to a second address range associated with the address space of the memory 208, the first and second address ranges being non-overlapping.

Each memory access request transmitted by the master devices 202 specifies (e.g., includes) an address associated with the address space of the memory 208. For example, where two slave devices are being implemented, as shown in the illustrated system embodiment depicted in FIG. 2, each memory access request can specify (e.g., include) an address which falls within either the first address range or the second address range. Further, any of the master devices 202 can be configured for accessing the complete address space (e.g., 512 MB address space) of the memory 208 via bus interconnects 206, 207.

In embodiments, the system 200 can further include address mapping logic (e.g., address remap logic) 212. The address mapping logic 212 can be implemented as hardware, software, and/or firmware. The address mapping logic 212 can be configured (e.g., connected) between the first bus interconnect 206 and the second bus interconnect 207. The address mapping logic 212 can further be configured for receiving the memory access requests from the master devices 202 via the first bus interconnect 206 and for implementing address interleaving for causing the memory access requests to be selectively routed to the slave devices 204 via the second bus interconnect 207. The address mapping logic 212 can be configured for determining a value of a selected bit (e.g., binary digit) of the address specified in a memory access request transmitted from a master device 202. Selection of the address bit upon which address interleaving can be based can be determined by the cache-line size of the cache of the master device 202 which transmitted the memory access request. For example, the mapping logic 212 can be configured for determining a value of bit [5] of the address specified in the transmitted memory access request. It is contemplated that selection of the address bit (e.g., the address bit to be interleaved) can be determined based upon other metrics besides or in addition to the cache-line size, such as the application and/or usage model. For example, if an application performs only 64-byte transfers to memory, then the selected bit (e.g., the interleaving bit) can be bit [6] of the address specified in the memory access request and the mapping logic 212 can be configured for determining a value of bit [6] of the address specified in the transmitted memory access request. Further, the address mapping logic 212 can be further configured for, when the value of the bit is determined as being a first value, causing the memory access request to be routed, via the second bus interconnect 207, to a first slave device included in the plurality of slave devices 204. For example, when the value of the bit (e.g., bit [5]) is determined as being “0”, the address mapping logic 212 causes the memory access request to be routed, via the second bus interconnect 207, to a first slave device (e.g., “memory controller 0” or “slave 0”, as indicated in FIG. 2) included in the plurality of slave devices 204. Still further, the address mapping logic 212 can be further configured for, when the value of the bit is determined as being a second value, the second value being a different value than the first value, causing the memory access request to be routed, via the second bus interconnect 207, to a second slave device included in the plurality of slave devices 204. For example, when the value of the bit (e.g., bit [5]) is determined as being “1”, the address mapping logic 212 causes the memory access request to be routed, via the second bus interconnect 207, to a second slave device (e.g., “memory controller 1” or “slave 1”, as indicated in FIG. 2). The address mapping logic 212 can be configured for causing the memory access request to be routed, via the second bus interconnect 207, to the second slave device 204 through implementation of address interleaving, which includes routing bit [5] of the address specified in the memory access request to a Most Significant Bit (MSB) [31] address bit. In other embodiments, (e.g., such as those in which the cache-line size of the cache of the master device 202 which transmitted the memory access request is 64 bytes) bit [6] of the address specified in the memory access request can be routed to MSB [31]. This causes the address specified in the memory access request to effectively be changed to an address (e.g., a remap address) which causes the second bus interconnect 207 to route it to the second slave device. For example, if the address as specified in the transmitted memory access request falls within the first address range, but the value of the selected bit is determined as being a value which dictates that the memory access request is to be routed to the second slave device, the address may be changed to a remap address which falls within the second address range.

In embodiments, the address remap logic 212, by implementing address interleaving as described above, allows for memory access requests to be routed in such a manner so that they are equally distributed amongst the slave devices 204. This promotes reduction of access latency, improved memory throughput, and improved overall performance of the system 200. The above-referenced address remapping functionality implemented by the address remap logic 212 can be easily scalable for adapting to any number of masters and slaves.

In the embodiment illustrated in FIG. 2, the second bus interconnect (e.g., a 2×2 interconnect) 207 can be configured for promoting avoidance of address conflict. Further, the first bus interconnect 206 can be configured with multiple (e.g., two) output ports (e.g., slave ports, indicated in FIG. 2 as “SA0” and “SA1”). The number of output ports of the first bus interconnect 206 can be dependent on bandwidth requirements of the system 200. Still further, the second bus interconnect 207 can be configured as a dedicated bus interconnect for the slave devices 204.

FIG. 4 is a flowchart illustrating a method for memory access request routing in a multi-processor system. The method 400 can include the step of receiving a memory access request transmitted from a master device 402. The method 400 can further include the step of determining a value of a selected bit of an address specified in the memory access request 404. Selection of the address bit can be determined by the cache-line size of the cache of the master device which transmitted the memory access request. For example, the selected bit can be bit [5] of the address specified in the memory access request. It is contemplated that selection of the address bit (e.g., the address bit to be interleaved) can be determined based upon other metrics besides or in addition to the cache-line size, such as the application and/or usage model. For example, if an application performs only 64-byte transfers to memory, then the selected bit (e.g., the interleaving bit) can be bit [6] of the address specified in the memory access request and a value of bit [6] of the address specified in the transmitted memory access request can be determined.

The method 400 can further include the step of, based upon the determined value of the selected bit of the address specified in the memory access request, causing the memory access request to be selectively routed, via a bus interconnect, to a first slave device or a second slave device 406. For example, the step of causing the memory access request to be selectively routed to the first slave device or the second slave device (step 406) can further include: when the value of the bit (e.g., bit [5]) is determined as being “0”, the memory access request can be routed, via the bus interconnect, to the first slave device 408. Further, the step of causing the memory access request to be selectively routed to the first slave device or the second slave device can further include: when the value of the bit (e.g., bit [5]) is determined as being “1”, the memory access request can be routed, via the bus interconnect, to the second slave device 410. Still further, the step of causing the memory access request to be selectively routed to the first slave device or the second slave device (step 406) can further include the step of: changing the address specified in the memory access request to a remap address for causing selective routing of the memory access request to the first slave device or the second slave device 412.

It is to be noted that the foregoing described embodiments may be conveniently implemented using conventional general purpose digital computers programmed according to the teachings of the present specification, as will be apparent to those skilled in the computer art. Appropriate software coding may readily be prepared by skilled programmers based on the teachings of the present disclosure, as will be apparent to those skilled in the software art.

It is to be understood that the embodiments described herein may be conveniently implemented in forms of a software package. Such a software package may be a computer program product which employs a non-transitory computer-readable storage medium including stored computer code which is used to program a computer to perform the disclosed functions and processes disclosed herein. The computer-readable medium may include, but is not limited to, any type of conventional floppy disk, optical disk, CD-ROM, magnetic disk, hard disk drive, magneto-optical disk, ROM, RAM, EPROM, EEPROM, magnetic or optical card, or any other suitable media for storing electronic instructions.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A multi-processor system, comprising:
a plurality of master devices configured for generating and transmitting memory access requests;
at least one bus interconnect communicatively coupled with the plurality of master devices; and
a plurality of slave devices communicatively coupled to the plurality of master devices via the bus interconnect, the plurality of slave devices configured for receiving the transmitted memory access requests via the at least one bus interconnect;
wherein the multi-processor system implements address mapping logic for causing the transmitted memory access requests to be selectively routed to either a first slave device included in the plurality of slave devices or a second slave device included in the plurality of slave devices based upon a value of a selected address bit of each memory access request.

2. The multi-processor system as claimed in claim 1, further comprising:
a memory communicatively coupled with the plurality of slave devices and the plurality of master devices.

3. The multi-processor system as claimed in claim 1, wherein the plurality of master devices are processors.

4. The multi-processor system as claimed in claim 1, wherein each transmitted memory access request is based on a cache-line size of the transmitting master device included in the plurality of master devices.

5. The multi-processor system as claimed in claim 1, wherein the plurality of slave devices are memory controllers.

6. The multi-processor system as claimed in claim 1, wherein the at least one bus interconnect includes at least one of: an Advanced Microcontroller Bus Architecture High-Performance Bus interconnect; an Advanced eXtensible Interface interconnect; and a 2×2 interconnect.

7. The multi-processor system as claimed in claim 1, wherein the multi-processor system is configured for being incorporated into a system on chip integrated circuit.

8. The multi-processor system as claimed in claim 1, wherein the address mapping logic is configured between the plurality of master devices and the at least one bus interconnect.

9. The multi-processor system as claimed in claim 1, wherein the address mapping logic is configured between a first bus interconnect of the at least one bus interconnect and a second bus interconnect of the at least one bus interconnect.

10. The multi-processor system as claimed in claim 1, wherein the address mapping logic implements address interleaving for causing the memory access requests to be selectively routed to either the first slave device included in the plurality of slave devices or the second slave device included in the plurality of slave devices.

11. The multi-processor system as claimed in claim 10, wherein the selected address bit of each memory request is bit [5].

12. The multi-processor system as claimed in claim 11, wherein address interleaving includes routing bit [5] to a most significant bit [31].

13. A method for memory access request routing in a multi-processor system, the method comprising:
receiving a memory access request transmitted from a master device;
determining a value of a selected bit of an address specified in the memory access request; and
based upon the determined value of the selected bit of the address specified in the memory access request, causing the memory access request to be selectively routed, via a bus interconnect, to a first slave device or a second slave device.

14. The method claimed in claim 13, wherein the step of causing the memory access request to be selectively routed to a first slave device or a second slave device further includes:
when the value of the bit is determined as being zero, routing the memory access request to the first slave device; and
when the value of the bit is determined as being 1, routing the memory access request to the second slave device.

15. The method claimed in claim 14, wherein the step of causing the memory access request to be selectively routed to a first slave device or a second slave device further includes:
changing the address specified in the memory access request to a remap address for causing selective routing of the memory access request to the first slave device or the second slave device.

16. The method claimed in claim 13, wherein the selected bit is bit [5] of the address specified in the memory access request or bit [6] of the address specified in the memory access request.

17. A non-transitory computer-readable medium having computer-executable instructions for performing a method for memory access request routing in a multi-processor system, the method comprising:
receiving a memory access request transmitted from a master device;
determining a value of a selected bit of an address specified in the memory access request; and
based upon the determined value of the selected bit of the address specified in the memory access request, causing the memory access request to be selectively routed, via a bus interconnect, to a first slave device or a second slave device.

18. The non-transitory computer-readable medium as claimed in claim 17, wherein the step of causing the memory access request to be selectively routed to a first slave device or a second slave device further includes:
when the value of the bit is determined as being zero, routing the memory access request to the first slave device; and
when the value of the bit is determined as being 1, routing the memory access request to the second slave device.

19. The non-transitory computer-readable medium as claimed in claim 18, wherein the step of causing the memory access request to be selectively routed to a first slave device or a second slave device further includes:
changing the address specified in the memory access request to a remap address for causing selective routing of the memory access request to the first slave device or the second slave device.

20. The non-transitory computer-readable medium as claimed in claim 17, wherein the selected bit is bit [5] of the address specified in the memory access request or bit [6] of the address specified in the memory access request.
